(19) United States
(12) Patent Application Publication
(10) Pub. No.: US 2024/0339279 A1
(43) Pub. Date: Oct. 10, 2024

(54) BUTTON AND ELECTRONIC DEVICE

(71) Applicant: AAC Technologies (Nanjing) Co., Ltd., Nanjing (CN)

(72) Inventors: Xingzhi Huang, Nanjing (CN); Wei Song, Nanjing (CN); Xiaofeng Pu, Nanjing (CN); Lubin Mao, Nanjing (CN); Yun Tang, Nanjing (CN); Jie Ma, Nanjing (CN)

(21) Appl. No.: 18/395,659

(22) Filed: Dec. 25, 2023

Related U.S. Application Data
(63) Continuation of application No. PCT/CN2023/087006, filed on Apr. 7, 2023.

(51) Int. Cl. H01H 71/24; G06F 3/01

(52) U.S. Cl. CPC H01H 71/2454; G06F 3/016; H01H 71/2481

(57) ABSTRACT

A button and electronic device, including shell and motor connected to the shell, the motor includes base and magnetic circuit, accommodating space is formed in the base, at least part of the magnetic circuit is accommodated in the accommodating space. The magnetic circuit at least includes magnetic conductive cover plate, voice coil and iron core, the magnetic conductive cover plate is fixedly connected to the shell and movably connected to the base. The voice coil and the iron core are accommodated in the accommodating space and are fixedly connected to the base, the voice coil is sleeved on the iron core, preset gap is formed between the iron core and the magnetic conductive cover plate. The voice coil and the iron core drive the magnetic conductive cover plate to drive the shell to move. The button can achieve feedback function to the user, thereby improving accuracy of user operation.

### CROSS-REFERENCE TO RELATED APPLICATIONS

The present disclosure is a continuation of International Application No. PCT/CN2023/087006, filed on Apr. 7, 2023, the content of which is incorporated herein by reference in its entirety.

### TECHNICAL FIELD

The invention relates to the technical field of mobile terminals, in particular to a button and electronic device.

### BACKGROUND

With the development of science and technology, electronic devices such as smart phones, earphones, glasses and the like gradually incorporate into peoples' daily life and working environment. Users can operate the electronic device through a button on the electronic device, so that the electronic device implements different functions and achieves different effects. However, the button on conventional electronic devices has poor feedback effects to the users, it is difficult for the users to confirm whether the user effectively operates the button, which results in low accuracy of the users' operations and thus poor user experience.

Therefore, it is necessary to provide a button and an electronic device to solve the above problems.

### SUMMARY

The invention aims to provide a button and an electronic device that can provide force feedback to the user.

The technical solution of the present disclosure is as follows.

A first aspect of the present disclosure provides a button, including a shell and a motor, the motor is connected to the shell. The motor includes a base and a magnetic circuit, an accommodating space is formed in the base, and at least part of the magnetic circuit is accommodated in the accommodating space. The magnetic circuit at least includes a magnetic conductive cover plate, a voice coil, and an iron core. The magnetic conductive cover plate is located on one side of the base. The magnetic conductive cover plate is fixedly connected to the shell and is movably connected to the base. The voice coil and the iron core are accommodated in the accommodating space and both fixedly connected to the base. The voice coil is sleeved on the iron core. Along a thickness direction of the motor, a preset gap is provided between the iron core and the magnetic conductive cover plate. The voice coil and the iron core are configured to drive the magnetic conductive cover plate to drive the shell to move in the thickness direction of the motor.

As an improvement, the magnetic circuit includes two iron cores and two voice coils. The two iron cores are arranged along a length direction of the motor. The two voice coils are respectively sleeved on the corresponding iron cores, and directions of current in the two voice coils are opposite to each other.

As an improvement, the motor further includes at least one elastic member, in the thickness direction of the motor, the elastic member is located between the magnetic conductive cover plate and the base, one end of the elastic member is connected to the magnetic conductive cover plate, and the other end of the elastic member is connected to the base.

As an improvement, the elastic member is a flat spring.

As an improvement, the motor further includes a first welding tab and a second welding tab, in a length direction of the motor, the first welding tab and the second welding tab are located on two sides of the elastic member and connected to the elastic member. In a thickness direction of the motor, the first welding tab and the second welding tab are located between the magnetic conductive cover plate and the elastic member, the first welding tab is connected to the magnetic conductive cover plate, and a gap is formed between the second welding tab and the magnetic conductive cover plate.

As an improvement, the motor includes two elastic members, in a length direction of the motor, the two elastic members are located on two sides of the base, and the voice coil and the iron core are located between the two elastic members.

As an improvement, the motor further includes a circuit board located in the accommodating space and connected to the base; the voice coil is located on a side of the circuit board away from the base, and is electrically connected to the circuit board; the circuit board is provided with at least one through hole along the thickness direction of the motor, and the iron core is located in the corresponding through hole.

As an improvement, the base is a magnetic conductor, the base includes a bottom plate and two side plates, the bottom plate and the two side plates enclose to form the accommodating space. The two side plates are located on two sides of the bottom plate and fixedly connected to the bottom plate, and the two side plates both extend in the thickness direction of the motor.

As an improvement, the button further includes a sensor configured to detect operation of the button, and the sensor is electrically connected to the motor.

A second aspect of the present disclosure provides an electronic device, including a body and a button mounted on the body, and the button is the button as described above.

The present disclosure has the following beneficial effects: the button can perform force feedback to the user through the motor after the user operates the button, which serves as a prompt for the user to confirm their operation. This design is beneficial to improving the accuracy of the user's button operation and thus enhancing the user's experience.

### BRIEF DESCRIPTION OF DRAWINGS

FIG. 1 is a cross-sectional view of a button according to the present disclosure;

FIG. 2 is an exploded schematic diagram of a motor of a button according to the present disclosure;

FIG. 3 is a schematic diagram of an appearance of a motor of a button according to the present disclosure;

FIG. 4 is a cross-sectional view of a motor of a button according to the present disclosure;

FIG. 5 is a schematic diagram of an electronic device according to a first embodiment of the present disclosure;

FIG. 6 is a schematic diagram of an electronic device according to a second embodiment of the present disclosure.

### REFERENCE SIGNS

1-shell;
2-motor;
   21-base;
      211-accommodating space
      212-bottom plate;
      213-side plate;
   22-magnetic circuit;
      221-magnetic conductive cover plate;
      222-voice coil;
      223-iron core;
   23-elastic member;
   24-first welding tab;
   25-second welding tab;
   26-circuit board;
      261-through hole;
3-electronic device;
   31-body.

### DESCRIPTION OF EMBODIMENTS

The present disclosure is further described below with reference to the accompanying drawings and embodiments.

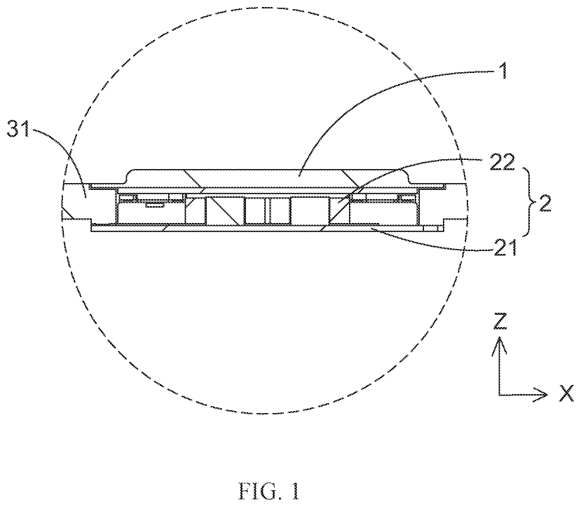

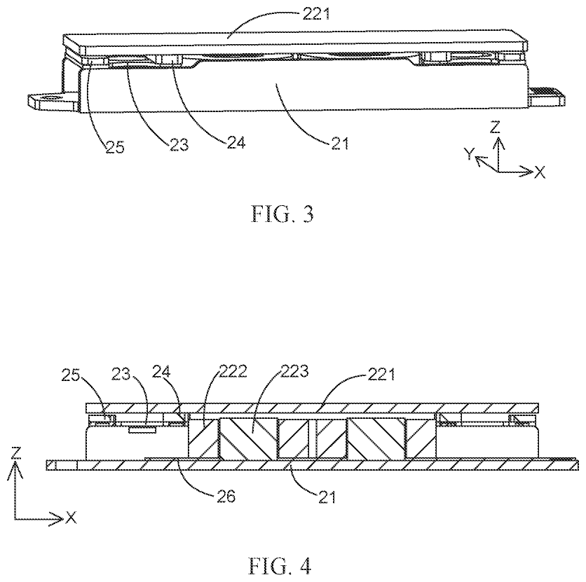

As shown in FIG. 1 to FIG. 4, the present disclosure provides a button, the button includes a shell 1 and a motor 2, and the motor 2 is connected to the shell 1. The motor 2 includes a base 21 and a magnetic circuit 22. An accommodating space 211 is formed in the base 21, and at least part of the magnetic circuit 22 is accommodated in the accommodating space 211. The magnetic circuit 22 at least includes a magnetic conductive cover plate 221, a voice coil 222, and an iron core 223. The magnetic conductive cover plate 221 is located on one side of the base 21. The magnetic conductive cover plate 221 is fixedly connected to the shell 1 and movably connected to the base 21. The voice coil 222 and the iron core 223 are accommodated in the accommodating space 211 and are both fixedly connected to the base 21. The voice coil 222 is sleeved on the iron core 223. Along a thickness direction Z of the motor 2, a preset gap is provided between the iron core 223 and the magnetic conductive cover plate 221, and the voice coil 222 and the iron core 223 are configured to drive the magnetic conductive cover plate 221 to drive the shell 1 to move in the thickness direction Z of the motor 2.

The shell 1 can be a button cap of a button, and the magnetic conductive cover plate 211 is fixed to the shell 1 and covers the base 21. The material of the magnetic conductive cover plate 221 and the iron core 223 can be iron cobalt alloy, or the material of the magnetic conductive cover plate 221 can also be other suitable magnetically conductive materials according to actual use requirements for the button, which is not limited herein. When the user presses the button, the motor 2 drives the shell 1 to move by the magnetic conductive cover plate 211, so as to perform force feedback to the user. After the user presses the button, the shell 1 drives the magnetic conductive cover plate 221 to move in a direction close to the base 21 under the action of an external force. The voice coil 222 is energized, so that the iron core 223 in the voice coil 222 is magnetized. A magnetic gap is formed between the iron core 223 and the magnetic conductive cover plate 221, so that a corresponding force is generated between the iron core 223 and the magnetic conductive cover plate 221. The direction of the force can be changed by changing the direction of the current in the voice coil 222, and the magnetic conductive cover plate 221 is driven by this force to move the shell 1 up and down, thereby achieving force feedback to the user, i.e., generating a simulated vibration for the user.

The present disclosure provides a motor 2 in the button, so that after the user operates the button, the button can perform force feedback to the user through the motor 2, and the feedback plays a role of prompting the user, thereby facilitating confirmation of their operation. This design is beneficial to improving the accuracy of the user's button operation, and is beneficial to improving the user's experience. On the other hand, the motor 2 in the present disclosure has a relatively simple structure. It is beneficial to reduce the overall volume of the motor 2 by simplifying the internal structure of the motor 2, thereby facilitating miniaturization of the button, and facilitating the user to perform accurate pressing operations, and thereby improving the user's experience.

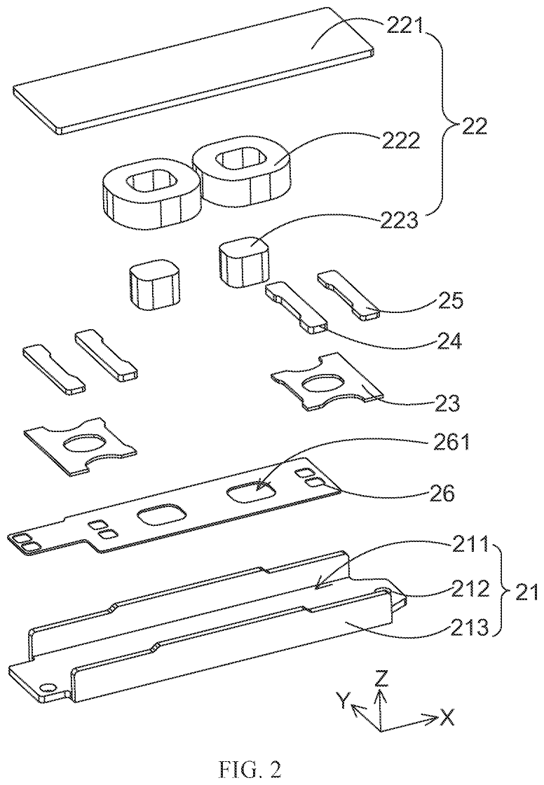

As shown in FIG. 2 to FIG. 4, in an embodiment, the magnetic circuit 22 includes two iron cores 223 and two voice coils 222. The two iron cores 223 are arranged in the length direction X of the motor 2. The two voice coils 222 are respectively sleeved on corresponding iron cores 223, and directions of current in the two voice coils 222 are opposite to each other.

After the two voice coils 222 are energized, the directions of current in the two voice coils 222 are opposite to each other. This arrangement enables a closed magnetic circuit to be formed in the motor 2, thereby increasing the force between the iron core 223 and the magnetic conductive cover plate 221, that is, increasing the driving force of the motor 2, and thus enabling the motor 2 to provide the user with more obvious force feedback.

As shown in FIG. 2 to FIG. 4, in an embodiment, the motor 2 further includes at least one elastic member 23. In the thickness direction Z of the motor 2, the elastic member 23 is located between the magnetic conductive cover plate 221 and the base 21. One end of the elastic member 23 is connected to the magnetic conductive cover plate 221, and the other end is connected to the base 21.

After the user presses the button, the elastic member 23 is compressed by an external force. After the voice coil 222 is de-energized, the force between the iron core 223 and the magnetic conductive cover plate 221 disappears, and the magnetic conductive cover plate 221 and the shell 1 can be reset under the action of the elastic member 23.

By providing the elastic member 23 between the magnetic conductive cover plate 221 and the base 21, it is beneficial to achieve automatic reset of the magnetic conductive cover plate 221 and the shell 1, thereby facilitating repeated use of the button by the user. In addition, the elastic member 23 also supports the magnetic conductive cover plate 221 and the shell 1, thereby improving the stability of the magnetic conductive cover plate 221 on the shell 1, and further facilitating the operation of the user.

In an embodiment, the elastic member 23 is a flat spring.

The flat spring is relatively simple to process and convenient to assemble. In addition, the use of the flat spring is also beneficial to saving the space inside the motor 2, thereby realizing the miniaturization design of the motor 2, and saving the volume of the entire button.

As shown in FIG. 2 to FIG. 4, in an embodiment, the motor 2 further includes a first welding tab 24 and a second welding tab 25. In the length direction X of the motor 2, the first welding tab 24 and the second welding tab 25 are respectively located on two sides of the elastic member 23 and connected to the elastic member 23. In the thickness direction Z of the motor 2, the first welding tab 24 and the second welding tab 25 are located between the magnetic conductive cover plate 221 and the elastic member 23. The first welding tab 24 is connected to the magnetic conductive cover plate 221, and a gap is formed between the second welding tab 25 and the magnetic conductive cover plate 221.

One end of the elastic element 23 having the first welding tab 24 is a free end that can move up and down, while the other end of the elastic element 23 having the second welding tab 25 is a fixed end that is fixed to the base 21. The elastic member 23 is fixed to the magnetic conductive cover plate 221 through the first welding tab 24, and there is a certain gap between the second welding tab 25 and the magnetic conductive cover plate 221, thereby providing a space for the movement of the magnetic conductive cover plate 221. When the user presses the button down until the magnetic cover plate 221 abuts against the second welding plate 25, the button is pressed in place and cannot move further. For example, the first solder tab 24 and the second solder tab 25 can be made of stainless steel.

By providing the first welding tab 24, the stability of the connection between the elastic member 23 and the magnetic conductive cover plate 221 can be improved, thereby facilitating the automatic reset of the magnetic conductive cover plate 211 through the elastic member 23. The movement range of the magnetic conductive cover plate 221 can be limited by providing the second welding tab 25, making it easier for the user to operate the button.

As shown in FIG. 2 to FIG. 4, in an embodiment, the motor 2 includes two elastic members 23. In the length direction X of the motor 2, the two elastic members 23 are located on two sides of the base 21, and the voice coil 222 and the iron core 223 are located between the two elastic members 23.

By providing the two elastic members 23, a more stable and uniform restoring force can be obtained for the magnetic conductive cover plate 221, further facilitating the automatic reset of the magnetic conductive cover plate 221. In addition, by this design, both ends of the magnetic conductive cover plate 221 are supported by the elastic members 23, which is beneficial to further improving the stability of the magnetic conductive cover plate 221.

As shown in FIG. 2 and FIG. 4, in an embodiment, the motor 2 further includes a circuit board 26. The circuit board 26 is located in the accommodating space 211 and connected to the base 21. The voice coil 222 is located on one side of the circuit board 26 away from the base 21, and is electrically connected to the circuit board 26. The circuit board 26 is provided with at least one through hole 261 in a thickness direction Z of the motor 2, and the iron core 223 is located in the corresponding through hole 261.

The circuit board 26 can be a flexible circuit board fixed at the bottom of the base 21. The circuit board 26 can be connected to an external power source to supply power to the voice coil 222 to drive the magnetic conductive cover plate 221 to move. The iron core 223 can be located in the through hole 261, so that the iron core 223 directly abuts against the base 21. Providing the through hole 261 can reduce the possibility of interference between the circuit board 26 and the iron core 223.

As shown in FIG. 2, in an embodiment, the base 21 is a magnetic conductor. The base 21 includes a bottom plate 212 and two side plates 213. The bottom plate 212 and the two side plates 213 enclose to form the accommodating space 211. The two side plates 213 are respectively located on two sides of the bottom plate 212 and fixedly connected to the bottom plate 212, and the two side plates 213 both extend in the thickness direction Z of the motor 2.

The base 21 can be made of an iron-cobalt alloy, or other magnetic conductive materials selected according to actual use requirements for the button. The side plate 213 can be perpendicularly disposed on the bottom plate 212, thereby protecting and limiting the elements inside the accommodating space 211.

By providing the base 21 as a magnetic conductor, it is further beneficial to form a closed magnetic circuit in the motor 2, thereby providing a greater driving force for the magnetic conductive cover plate 221, and further enhancing the effect of button force feedback, so as to improve the user's experience and accuracy of user's operation.

In an embodiment, the button further includes a sensor (not shown in the figures), which is configured to detect operations to the button, and electrically connected to the motor 2.

The sensor can be configured to detect information such as a pressing position and a pressing force of the user on the button. Based on this information, the user's specific operating methods can be determined, such as whether the button is being pressed or slid. After the user operates the button, the sensor can detect that the magnetic conductive cover plate 221 has moved. At this time, the voice coil 222 can be energized, so that a force is generated between the iron core 223 and the magnetic conductive cover plate 221, thereby realizing force feedback to the user.

By arranging the sensor, the button detection function can be realized, so that the user can use the button conveniently, and the user's experience is improved.

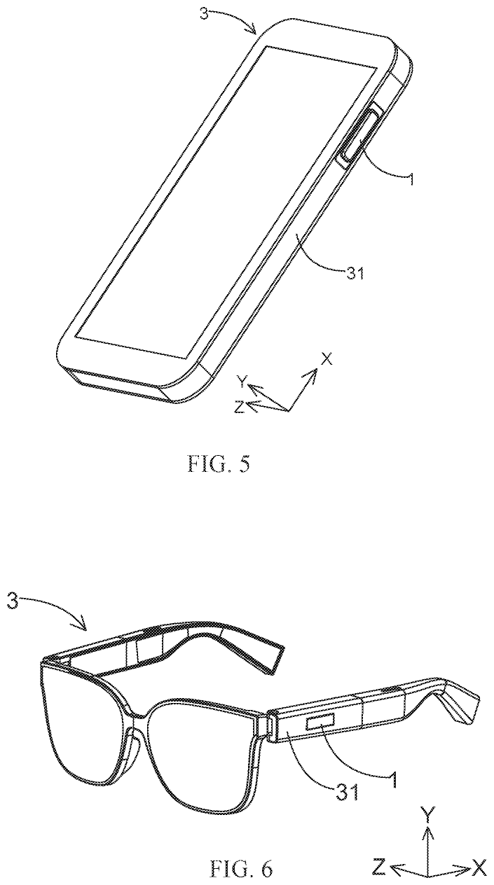

As shown in FIG. 1, FIG. 5 and FIG. 6, the present disclosure further provides an electronic device 3, including a body 31 and a button. The button is installed on the body 31, which is any one of the above buttons.

The electronic device 3 can be a mobile phone, an earphone, a handle, a steering wheel, a VR device, an AR device, or the like, which is not limited herein. The body 31 can be a middle frame of the electronic device 3, and the button can be a side button of the electronic device 3. The base 21 of the motor 2 can be fixed on the body 31. The user can perform operations such as clicking and sliding the button on the body 31 to control the electronic device 3. The sensor in the button can feed back the detected pressing position, pressing force and other information to the electronic device 3. The electronic device 3 can identify the action of the user according to the feedback result of the sensor, thereby enabling the electronic device 3 to perform corresponding operations. The specific process may be as follows: the user operates the button by applying an external force to the button. Under the action of the external force, the magnetic conductive cover plate 221 can move to a side close to the base 21. At this time, the elastic member 23 is compressed. The sensor detects that the magnetic conductive cover plate 221 has moved. The voice coil 222 is energized to magnetize the iron core 223. A force is generated between the iron core 223 and the magnetic conductive cover plate 221. The magnetic conductive cover plate 221 can provide force feedback to the user after receiving the force. The sensor also detects information such as a pressing position and a pressing force. The electronic device 3 uses the detection result of the sensor to operate the entire device, and can call an effect library according to the detection result of the sensor to achieve the effect of pressing or sliding the button.

By providing the above button as described in the above embodiments, it is beneficial to implement timely interaction between the electronic device 3 and the user, and can provide rich control experience for the user, so that the user can perform different operations on the button to implement different functions and effects of the electronic device 3, thereby improving the convenience of use of the electronic device 3. Moreover, the electronic device 3 can provide corresponding force feedback for the user after the user operates the button to prompt the user, thereby improving the accuracy of the user operation and further improving the user experience.

The above are only embodiments of the present disclosure, and it should be noted herein that those skilled in the art can also make modifications or improvements without departing from the concept of the present disclosure, but these modifications or improvements are all within the protection scope of the present disclosure.

What is claimed is:

1. A button, comprising:
a shell;
a motor connected to the shell;
wherein the motor includes a base and a magnetic circuit, an accommodating space is formed in the base, and at least part of the magnetic circuit is accommodated in the accommodating space;
the magnetic circuit at least comprises a magnetic conductive cover plate, a voice coil and an iron core, the magnetic conductive cover plate is located on one side of a base; the magnetic conductive cover plate is fixedly connected to the shell and is movably connected to the base; the voice coil and the iron core are accommodated in the accommodating space and fixedly connected to the base; the voice coil is sleeved on the iron core; along a thickness direction of the motor, a preset gap is formed between the iron core and the magnetic conductive cover plate; and the voice coil and the iron core are configured to drive the magnetic conductive cover plate to drive the shell to move in the thickness direction of the motor.

2. The button as described in claim 1, wherein the magnetic circuit comprises two iron cores and two voice coils, the two iron cores are arranged along a length direction of the motor, the two voice coils are respectively sleeved on the corresponding iron cores, and directions of current in the two voice coils are opposite to each other.

3. The button as described in claim 1, wherein the motor further comprises at least one elastic member, in the thickness direction of the motor, the elastic member is located between the magnetic conductive cover plate and the base, one end of the elastic member is connected to the magnetic conductive cover plate, and the other end of the elastic member is connected to the base.

4. The button as described in claim 3, wherein the elastic member is a flat spring.

5. The button as described in claim 4, wherein the motor further comprises a first welding tab and a second welding tab, in a length direction of the motor, the first welding tab and the second welding tab are located on two sides of the elastic member and connected to the elastic member; in a thickness direction of the motor, the first welding tab and the second welding tab are located between the magnetic conductive cover plate and the elastic member, the first welding tab is connected to the magnetic conductive cover plate, and a gap is formed between the second welding tab and the magnetic conductive cover plate.

6. The button as described in claim 4, wherein the motor comprises two elastic members, in a length direction of the motor, the two elastic members are located on two sides of the base, and the voice coil and the iron core are located between the two elastic members.

7. The button as described in claim 1, wherein the motor further comprises a circuit board located in the accommodating space and connected to the base; the voice coil is located on a side of the circuit board away from the base, and is electrically connected to the circuit board; the circuit board is provided with at least one through hole along the thickness direction of the motor, and the iron core is located in the corresponding through hole.

8. The button as described in claim 1, wherein the base is a magnetic conductor, the base comprises a bottom plate and two side plates, the bottom plate and the two side plates enclose to form the accommodating space; the two side plates are located on two sides of the bottom plate and fixedly connected to the bottom plate, and the two side plates both extend in the thickness direction of the motor.

9. The button as described in claim 1, wherein the button further comprises a sensor configured to detect operation of the button, and the sensor is electrically connected to the motor.

10. An electronic device, comprising:
a body;
a button mounted on the body, wherein the button comprises:
a shell;
a motor connected to the shell;
wherein the motor includes a base and a magnetic circuit, an accommodating space is formed in the base, and at least part of the magnetic circuit is accommodated in the accommodating space;
the magnetic circuit at least comprises a magnetic conductive cover plate, a voice coil and an iron core, the magnetic conductive cover plate is located on one side of a base; the magnetic conductive cover plate is fixedly connected to the shell and is movably connected to the base; the voice coil and the iron core are accommodated in the accommodating space and fixedly connected to the base; the voice coil is sleeved on the iron core; along a thickness direction of the motor, a preset gap is formed between the iron core and the magnetic conductive cover plate; and the voice coil and the iron core are configured to drive the magnetic conductive cover plate to drive the shell to move in the thickness direction of the motor.
